(19) United States
(12) Patent Application Publication
(10) Pub. No.: US 2022/0020074 A1
(43) Pub. Date: Jan. 20, 2022

(54) System and Method for Automatically Generating Online Quote for Team or Service

(71) Applicant: SupportFinity Inc., San Jose, CA (US)

(72) Inventors: Mohamed Fawzy NADA, San Jose, CA (US); Walid Hazem Moussa, Giza (EG); Ahmed Alaaelden Shaarawy, Giza (EG); Nour Ahmed Abbas, Giza (EG)

(21) Appl. No.: 16/932,205

(22) Filed: Jul. 17, 2020

(51) Int. Cl. G06Q 30/06; G06Q 10/06; G06Q 10/10

(52) U.S. Cl. CPC G06Q 30/0611; G06Q 10/063112; G06Q 10/1053; G06Q 10/0637; G06Q 10/06315

(57) ABSTRACT

A system for automatically generating an online quote for a team or service is provided. The system includes a database including data on jobs and skills. The system includes a processor and an application. The application is configured to receive, via an online interface, qualification information required for either a team or a service in need and identify at least one match between the qualification information and the data in the database. The application is configured to process the qualification information and generate a quote for the at least one match for the team or service based on the processed qualification information. A method for generating a quote for a team or service is also provided.

### FIELD

The present application relates to a system and method for generating a quote, and in particular to a system and method for automatically generating an online quote for a team or service.

### BACKGROUND

Business to business (B2B) outsourcing is one of the fundamental needs across all businesses. While such needs exist among all business fields, software and technology sectors particularly are on top of businesses that rely on B2B outsourcing. In the software and technology sectors, businesses need various types of services and products to operate successfully. Since there exists virtually no single business that can itself provide all services and products needed for its business operations, there have been always various B2B models in order for all businesses to work together.

For the reasons described above, it is desirable to automate B2B transactions or outsourcing processes among businesses. However, due to the complex nature of B2B technical services transactions or outsourcing processes, it has not been possible to fully automate these transactions or outsourcing processes among businesses.

### SUMMARY OF THE INVENTION

In view of this background, it is an objective of the present application to provide a system and/or method for automating B2B technical services transactions or outsourcing processes among businesses. It is also an objective of the present disclosure to provide a system and/or method for automatically generating an online quote for a team or service. These and other objects are achieved by a system and method for automatically generating an online quote for a team or service in accordance with embodiments of the present application.

In accordance with one aspect of the present application, a system includes a database, a processor, and an application. The database may include data on jobs, skills, and/or candidates. The application is executed by the processor. The application is configured to receive, via an online interface, qualification information required for either a team or a service in need. The application is configured to identify at least one match between the qualification information and the data in the database. The application is configured to process the qualification information. The application is configured to generate a quote for the at least one match for the team or service based on the processed qualification information.

In accordance with another aspect of the present application, a method for generating a quote for a team or service, includes receiving, via an online interface, qualification information required for either a team or a service in need. The method also includes identifying at least one match between the qualification information and data in a database including data on jobs and skills. The method includes processing the qualification information. The method includes generating a quote for the at least one match for the team or service based on the processed qualification information.

### BRIEF DESCRIPTION OF THE DRAWINGS

FIG. 1 is a schematic illustration of a system for automatically generating an online quote for a team or service in accordance with an exemplary embodiment of the present application.

FIG. 2 is a schematic illustration of an online user interface in accordance with the exemplary embodiment of the present application.

FIG. 3 is a flow chart that shows utilizing fuzzy logic to display to the user relevant or related records from the database in accordance with the exemplary embodiment of the present application.

FIG. 4 is a schematic illustration of an online user input interface for entry of job title in accordance with the exemplary embodiment of the present application.

FIG. 5 is a flow chart that illustrates a process of matching calculation, using a trigram algorithm, to obtain a similarity between the record in the database and the user's input, and sorting database records according to the calculated similarity in accordance with the exemplary embodiment of the present application.

FIG. 6 is a diagram illustrating a structured database of job titles and skills in accordance with the exemplary embodiment of the present application.

FIG. 7 is a schematic illustration of a structure of a team and a structure of each group within the team in accordance with the exemplary embodiment of the present application.

FIG. 8 is a diagram illustrating a quote generation process in accordance with the exemplary embodiment of the present application.

FIG. 9 is a diagram illustrating a graph that connect categories together in accordance with the exemplary embodiment of the present application.

FIG. 10 is a flow chart that shows a process of selecting a parent match in accordance with the exemplary embodiment of the present application.

FIG. 11 is a flow chart that shows a process of identifying skills to be suggested to the user, which have higher correlation with the parent match in accordance with the exemplary embodiment of the present application.

FIG. 12 is a flow chart that shows a process of calculating a group coherence using a harmonic mean in accordance with the exemplary embodiment of the present application.

FIG. 13 is a diagram illustrating a process of start date calculation in accordance with the exemplary embodiment of the present application.

FIG. 14 is a schematic illustration of a display interface for multiple groups in accordance with the exemplary embodiment of the present application.

FIG. 15 is a diagram schematically illustrating a post-booking process in accordance with the exemplary embodiment of the present application.

FIG. 16 is a flow chart illustrating a process of generating a quote for a team or service in accordance with another exemplary embodiment of the present application.

### DETAILED DESCRIPTION

The following detailed description includes references to the accompanying figures. In the figures, similar symbols typically identify similar components, unless context dictates otherwise. The example embodiments described herein are not meant to be limiting. Other embodiments may be utilized, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein.

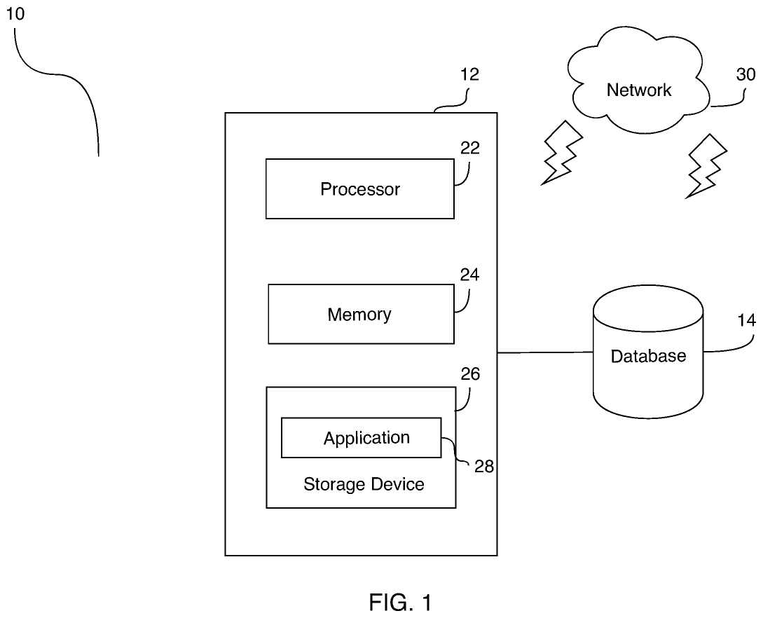

FIG. 1 is a schematic illustration of a system 10 for automatically generating an online quote for a team or service in accordance with an exemplary embodiment of the present application. It is worth noting that the system of the present application may include one or more mobile or non-mobile computer devices and one or more databases. Each of the mobile or non-mobile devices may include one or more respective processors, one or more memories, one or more storage devices, one or more input interfaces, and/or one or more output interfaces. One or more of the above-mentioned components may communicate with one another via a wired or wireless connection. For sake of brevity and explanatory purposes, the system 10 according to the first exemplary embodiment shown in FIG. 1 is illustrated using a single computer device 12 and a single database 14.

The system 10 includes the computer device 12 and the database 14. The computer device 12 may include a processor 22, a memory 24, and a storage device 26. The storage device 26 may include an application (or a computer program) 28 having one or more instructions, which, when executed by the processor 22, causes the processor 22 to perform one or more operations needed to automatically generate an online quote for a team or service. The database 14 includes data on jobs, skills, and candidates. While the database 14 is illustrated as an external database in the embodiment shown in FIG. 1, the database 14 may be provided internally within the computer device 12 (for example, saved in the storage device 26) in other embodiments. Commands or data may be communicated between the computer device 12 and the database 14 via a communication network 30, which may be one of wireless, wired, manual communication, and any combination thereof.

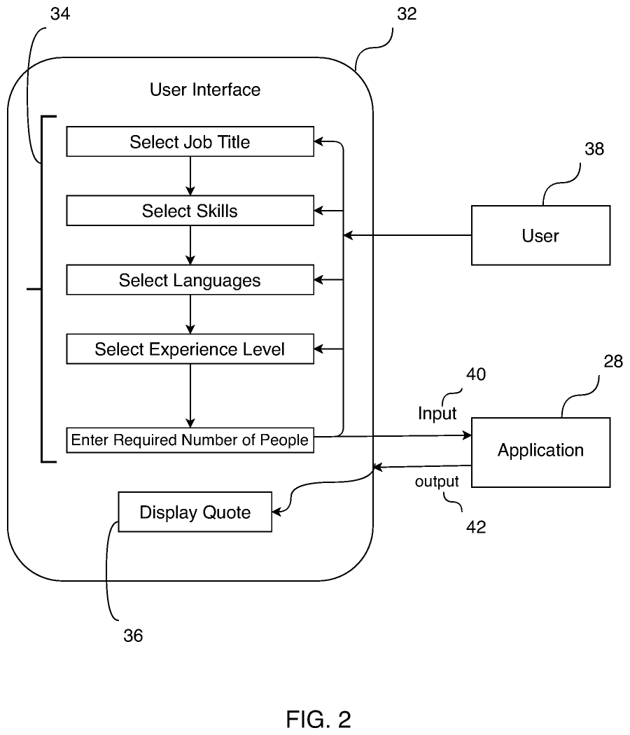

In a preferred embodiment, the application 28 is configured to receive, via an online user interface, qualification information required for a team or service in need from users. FIG. 2 illustrates an exemplary online user interface 32. Users may be, for example, businesses that intend to perform B2B transactions or outsourcing processes via the system 10. For another example, users may be businesses that wish to receive an online quote for a team or service in need, which is automatically generated upon entry of the qualification information into the system 10 from the users.

In accordance with one aspect of the present application, the user interface 32 may include an input interface 34 and an output interface 36. The system 10 receives qualification information required for a team or service in need from a user 38 via the input interface 34. Preferably, the application 28 is programmed to receive the qualification information via the input interface 34. The qualification information may include a job title, a skill, a language, an experience level, and a required number of people. The user 38 may enter the qualification information via the input interface 34 in the user interface 32 provided by the system 10. The user interface 32 may be a web-based graphical user interface. However, in other embodiments, any other type of user interface may be used without departing from the spirit and scope of the present application.

As described above, the qualification information from the user 38 may include a job title, a skill, a language, an experience level, and a required number of people or candidates. For example, the qualification information may be: a job title of needed candidates, skills that they should have, languages they can speak, years of experience they have, and the number of candidates required. An example of such requirements is presented in the table below.

| Job title | Skills | Languages | Experience | Size |
|---|---|---|---|---|
| Java Developer | Java, SQL | English | 1-3 years | 2 |

In the example shown in the table, the user 38 requests two Java Developers who have experience of 1-3 years of Java and SQL skills and good command of English language.

Once the qualification information is received from the user 38, the system 10, via the application 28, identifies one or more matches between the received qualification information and the data in the database 14. In addition, the system 10, via the application 28, processes the received qualification information. Subsequently, the system 10, via the application 28, generates a quote for the matches as an output 42 based on the processed qualification information. The output 42 (e.g., a quote) may be displayed to the user 38 via the output interface (or display interface) 36. These features will be described in detail below.

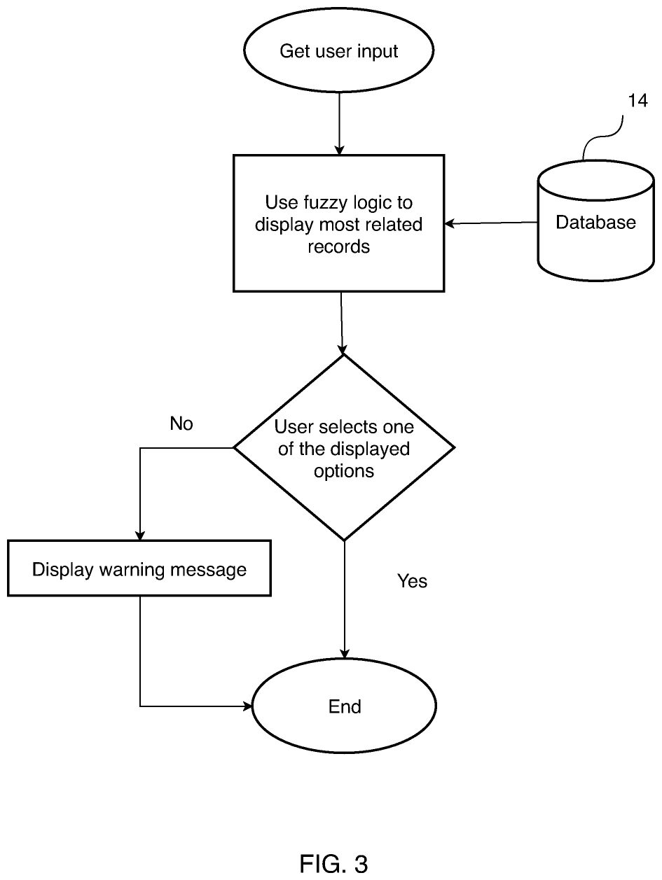

In an exemplary embodiment of the present application, the input interface 34 may include a search bar via which the user 38 can enter requirements for a team or service in need. After typing a requirement keyword(s) for job titles or skills, a list of job titles or skills is configured to be displayed in the input interface 34. This list is configured to be fetched from the database 14 based on what the user 38 typed. In some embodiments, to get the most relevant records in the list of job titles and skills, fuzzy logic may be used. Fuzzy logic is used to identify what the user 38 wants even when typing of the user 38 fails to exactly what is available in the database 14. FIG. 3 is a flow chart that shows utilizing fuzzy logic to display to the user 38 the most relevant or related records from the database 14.

The user 38 can then select from the displayed list. If the user 38 does not find what he is looking for from the displayed list, he may just leave what has been typed as it is or leave the field blank. In this case, the application 28 may categorize the user's attempt as an unsuccessful match between the user's input of the qualification information and the data in the database 14. To the contrary, if the user 38 selects an item from the displayed list, the application 28 may categorize the user's attempt as a successful match between the user's input of the qualification information and the data in the database 14. In this case, the application 28 may be configured to issue a warning message to the user 38, as illustrated in FIG. 3.

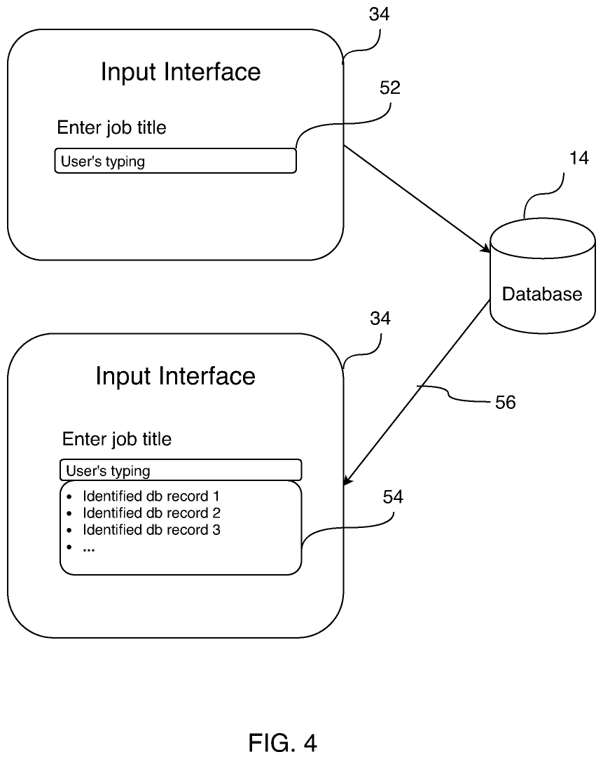

FIG. 4 illustrates an exemplary online user input interface 34 for entry of job title. Upon the user's typing 52 of a desired job title, a list of job titles is configured to be displayed in a designated area 54 in the input interface 34. This list is configured to be fetched 56 from the database 14 based on what the user 38 typed. Similar user input interface may be used for entry of skills and any other qualification information to be obtained from the user 38.

For each record in the database 14, the application 28 may be configured to calculate a similarity between the record in the database 14 and the user's input, and sort database records according to the calculated similarity. The N best matches may be shown to the user 38, where N is a predetermined positive integer. To calculate a similarity between the record in the database 14 and the user's input, the following index may be used:

Index=a1*Sentence starting exact matching (SSEM)+a2*Sentence anywhere exact matching (SAEM)+a3*Sentence similarity (SS)+a4*Word similarity (WS), wherein

a1, a2, a3, and a4 are constants;

SSEM: equals 1 if record starts with user's input exactly, else equals 0;

SAEM: equals 1 if record has any sequence of characters that is identical to user's input, else equals 0;

SS: returns a number between 0 and 1, which indicates how similar record and user's input are; and

WS: returns a number indicative of greatest similarity between user's input and any substring of record.

The above-described SS and WS may be calculated using a trigram algorithm. A trigram is a sequence of three consecutive characters in a string. For example, the trigrams of “Rails” are Rai, ail, and ils. The algorithm may split a string into words and determine trigrams for each word separately. It may also normalize the word by downcasing it, prefixing two spaces and suffixing one. Downcasing makes trigrams case-insensitive.

For example, “Ruby Rails” consists of two words, “Ruby” and “Rails,” that are handled separately. “Ruby” is normalized to ruby and its trigrams are r, ru, rub, uby, by. “Rails” is turned into rails thus the trigrams are r, ra, rai, ail, ils, and ls. The trigrams of the whole string are the sum of the trigrams of “Ruby” and “Rails.”

After getting the trigrams of the words that need to be compared, a similarity between them may be calculated using any similarity formula such as Jaccard index, formally

$$\frac{A ⋂ B}{A ⋃ B} ,$$

where A and B are the lists of trigrams of the two strings. A few examples of similarity calculations between the record in the database and the user's input are presented in the table below. In some embodiments, any database records that have a similarity higher than a predefined threshold may be categorized as matches for the user's input.

| User's Input | Database Record | Similarity | Notes |
|---|---|---|---|
| Android stud div | Android Studio Developer | 0.51 | Most Similar |
| Android stud div | RAD Studio Developer | 0.32 | |
| Android stud div | andLinux Administrator | 0.21 | Least Similar |

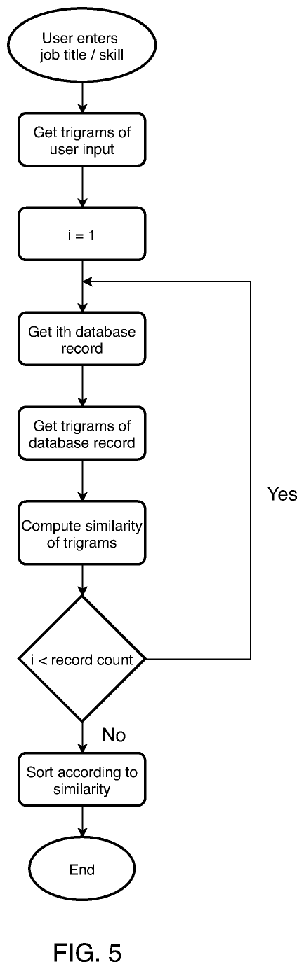

FIG. 5 illustrates the above-described process of calculating, using a trigram algorithm, a similarity between the record in the database 14 and the user's input, and sorting database records according to the calculated similarity.

In a preferred embodiment, the reception of the qualification information from the user 38, the identification of one or more matches between the received qualification information and the data in the database 14, the processing of the qualification information, and the generation of the quote are conducted without human intervention. In other words, the system 10 is a fully automated system such that no human or manual intervention is needed to generate a quote to the user 38.

Next, the database 14 of the system 10 is described. The database 14 includes data on jobs and skills. Preferably, the database 14 includes job titles and skills. For example, a job title is Java Developer and its corresponding skills are Java and SQL. The database 14 is preferably a structured database of job titles and skills, which includes descriptive or indicative data to be used for further processing.

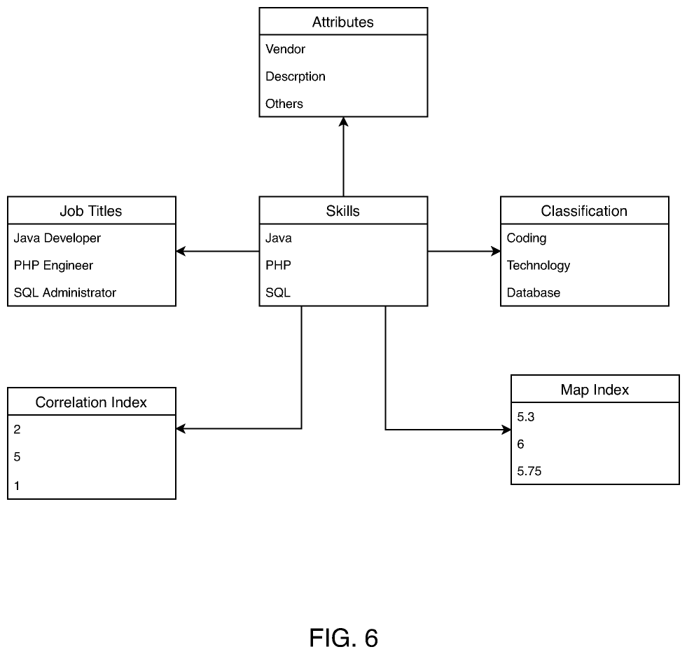

In a preferred embodiment, the database 14 is a structured schema of data types and labels that are essential for effective querying and data retrieval, and the database records are used for the mathematical, analytical and logical processing used by the application 28. FIG. 6 is a diagram illustrating such a structured database of job titles and skills.

In an embodiment of the present application, the skills data may include a schema of various tables that are connected to form a logical understanding for each skill record. The data may be structured in the form of star schema, where the skills table is the fact table and the others are the dimension tables as illustrated in FIG. 6.

The job titles table is connected to the skills table, where each job title record is connected or derived from at least one skill, thus processing of qualification information is always interlinked. The job titles are designed to cover almost all fields of expertise and knowledge areas. For example, in the software development industry, the scope of the job titles may cover design, test, development, management, planning, releasing, and maintenance. Similarly, this applies to other fields or industries.

In accordance with one aspect of the present application, users may request a quote for a service by inputting a single type of qualification information. Alternatively, users may request a quote for a team by inputting multiple types of qualification information.

The system 10 may provide an option of a service or a team to offer a deep level of customization to users. For example, each user can have similar qualification information grouped together, which enables the user 38 to create a team with more than one group, which makes the team customization feature more efficient to cater for multiple and diverse requirements of each user.

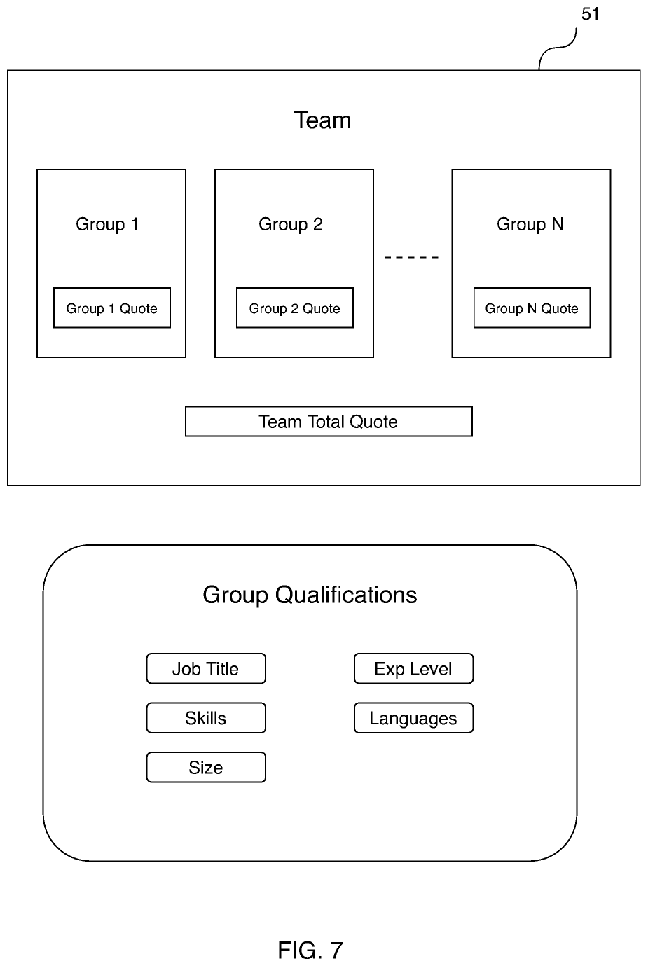

A simple form of a team is a team of one group. Users can increase the number of groups per each team as needed. FIG. 7 illustrates an exemplary structure of a team 51 and an exemplary structure of each group within the team 51. The team total quote shown in FIG. 7 is the sum of the quotes of each group. This way, the system 10 offers a detailed level of quotation information to users.

As shown in FIG. 7, the team 51 may include a plurality of groups. Each group may have a different set of the qualification information. The application 28 may be configured to generate a quote for each group.

In a preferred embodiment, the input interface 34 may request that users enter specific types of data as an input for the qualification information. For example, the qualification information for a service may include a job title, a skill, a language, an experience level, or a number of candidates. On the other hand, the qualification information for a team may include a job title or a skill, a language, an experience level, a number of candidates, and an engagement period.

For a quote to be generated to book a team needs to be precise as it is time bounded and the user must enter all needed qualification information. For a quote to be generated to book a service, precision increases with the increase of the user's qualification data inputs, thus it can achieve 100% precision when all qualification data is entered by the user. However, it should be noted that the composition of the qualification information of a service or a team can vary in other embodiments without departing from the scope of the present application.

Next, a quote generation process is described. The quote generation process may start when the user 38 finishes entering his/her qualification information for one of the groups. The first step in quote generation is to get a base price of the selected qualification information from the database 14. The next step is to select a qualification with the highest price. For illustration purposes, let's say that the user 38 chooses a python developer, who has a PhD in computer science. Since a PhD requirement is associated with a higher price, this price is determined as a base price for the team. This base price is then multiplied by a duration and a duration factor (df) to take the duration of the service for the team into consideration. The duration factor (df) may be rated to include a discount for a longer employment of a team or service.

Next, the output is multiplied by an experience factor (ef), which may be rated to give a higher price quote for demand for a higher amount of experiences. After that comes the language factor (lf). This may lead to a high price quote for demand for uncommon languages. The principal reason for this factor is that candidates who speak uncommon languages are harder to find, thus they are more costly. Then, the price is multiplied by a size factor (sf) to take the size of the team into consideration. The purpose of the size factor (sf) is to give lower prices for users requesting a bigger team size. The next factor is a billing cycle factor (bf). This is used to give a lower price for longer billing cycles. The last factor to be considered is a market present value adapter (mpv). This is used to adjust all prices according to the current market values.

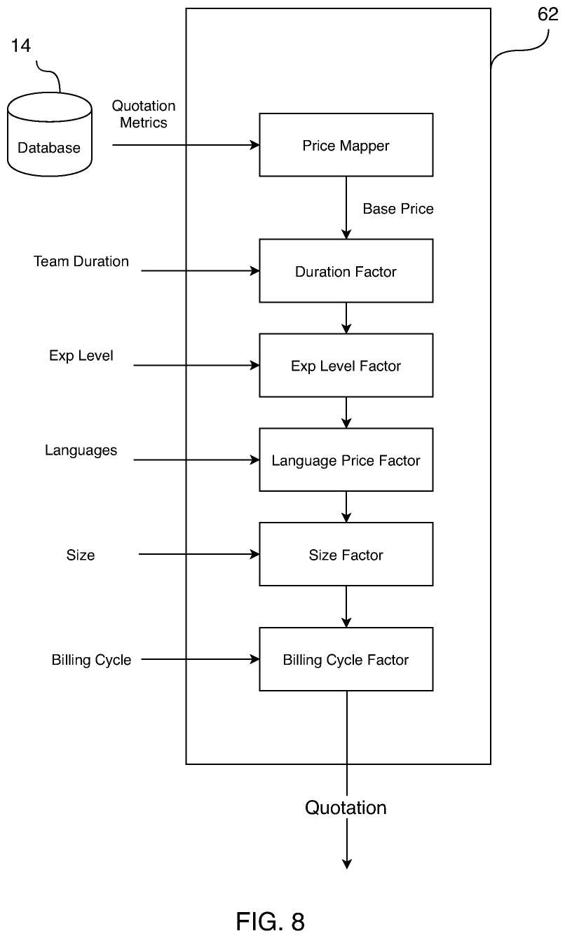

The above-described process may be applied to each group the user 38 creates. FIG. 8 illustrates an exemplary quote generation process 62. The total quote for the team is a sum of each group' quote. By way of this process 62, the system 10 generates, via an application 28, a quote for one or more identified matches using selected qualification information and corresponding data from the database 14.

The above-described quote generation process may be presented with the following equation:

$$Quotation = {\sum }_{n = 1}^{number of groups} base price * duration * df * ef * lf * size * sf * bf * mpv$$

wherein

df denotes a duration factor;

ef denotes an experience factor;

lf denotes a language factor;

sf denotes a size factor;

bf denotes a billing cycle factor; and

mpv denotes a market present value adapter.

Next, a correlation algorithm is described. An objective of the correlation algorithm is to measure a correlation between skills or job titles. A correlation between skills represents a probability to find someone who has mastered these skills. For this purpose, a categorizing technique is used, where each set of skill and job title is given a category. Now, the goal is to find a correlation between these categories.

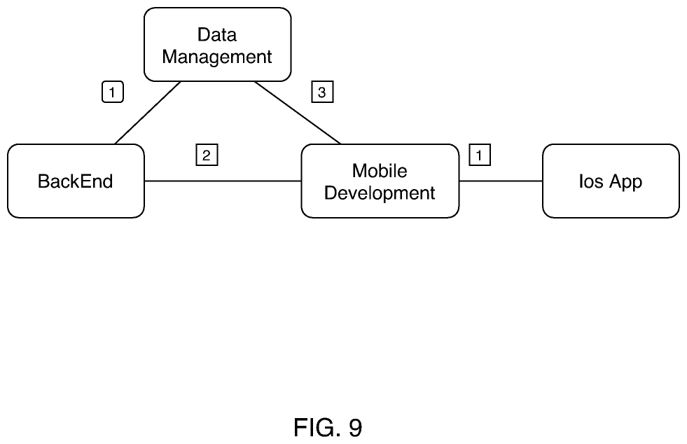

To find the correlation between two categories, a graph that connects all categories together may be built. In the graph, every category is considered a “node” and every connection is considered an “edge”. An example of such a graph is illustrated in FIG. 9. The distance between two nodes in the graph represents how far the corresponding categories are from each other. In the example shown in FIG. 9, the distance between “Backend” category and “Mobile Development” category is 3, while the distance between “Data Management” and “Ios App” is 4 (i.e., “Data Management”→“Mobile Development”→“Ios App”). The calculated distance between two categories may be categorized into 5 different levels: strong, good, okay, weak, and very weak. The correlation between two skills or two job titles is the inverse of the distance of their corresponding categories. In other words, shorter distances indicate higher correlations, while longer distances indicate lower correlations.

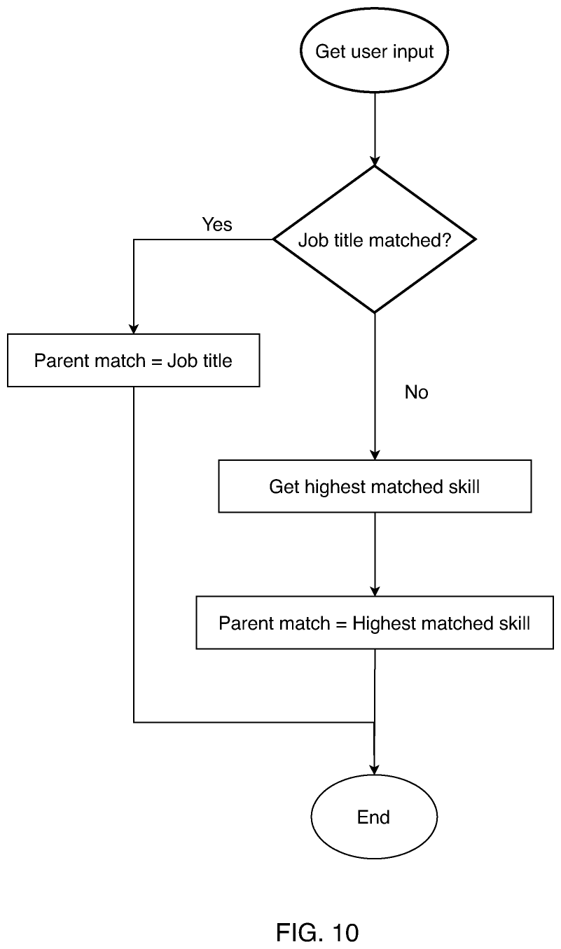

In a preferred embodiment, the application 28 may be configured to, by way of an algorithm, suggest other qualification information records that have higher correlation with matched data than the qualification information. For example, an artificial intelligence (AI) module or an AI algorithm may be used to suggest more correlated skills to the user 38 based on his selection. To provide useful suggestions to the user 38, a parent match must be determined first, as illustrated in FIG. 10. Here, a parent match represents the most important matched qualification information record selected by the user.

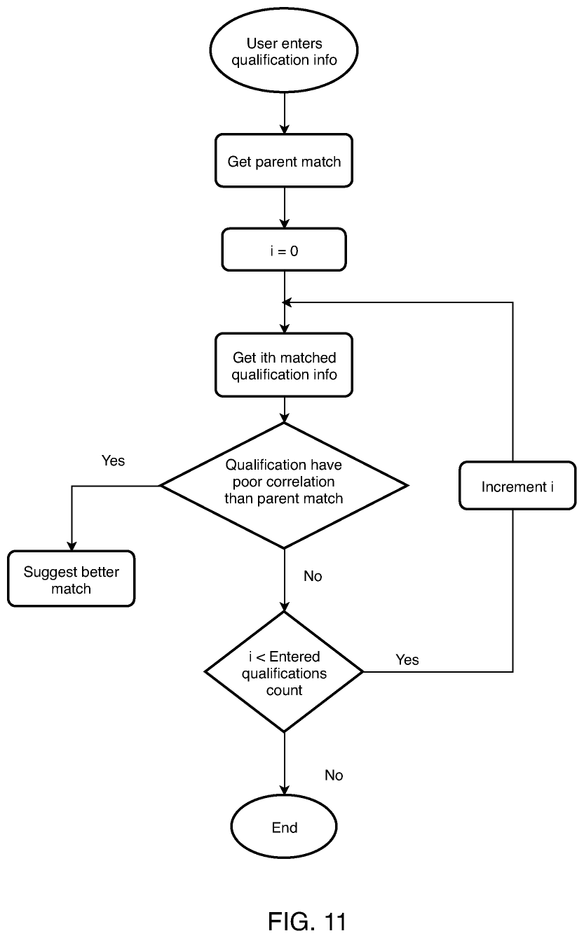

Once the parent match is determined, the application 28 is configured to identify skills to be suggested to the user 38, which have higher correlation than the determined parent match. This process is illustrated in FIG. 11.

In accordance with one aspect of the present application, an AI module may be used to determine a team coherence which represents the probability to find someone who matches the group's qualification requirements. An objective is to get the correlation between every pair of job title and skills in the group. Then, a harmonic mean of all pair correlations is used to determine a coherence of the whole group. The harmonic mean is used here to drag the coherence of the group down if any of the skills have very weak correlation because only one very weak correlation can make the entire requirement unrealistic. A harmonic mean may be calculated using the following formula:

$$H = \frac{n}{\frac{1}{{x}_{1}} + \frac{1}{{x}_{2}} + ⋯ + \frac{1}{{x}_{n}}} = \frac{n}{{\sum }_{i 1}^{n} \frac{1}{{x}_{i}}} = {( \frac{{\sum }_{i = 1}^{n} {{x}_{i}}^{- 1}}{n} )}^{1} .$$

wherein

H denotes a harmonic mean;

x denotes a pair correlation's value and

n denotes the number of pair correlations.

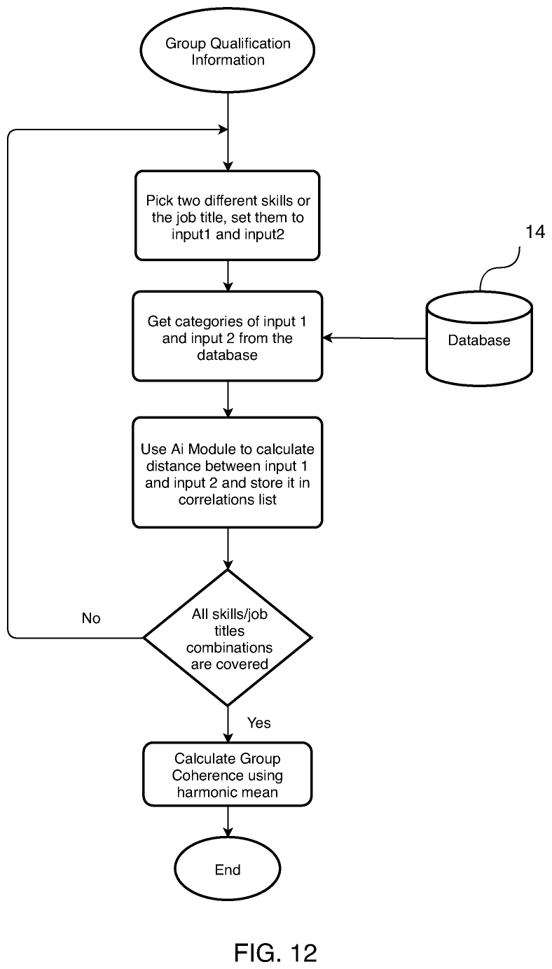

The above-describes process of calculating a group coherence using a harmonic mean is illustrated in FIG. 12.

Next, a candidate matching process is described. An objective of a candidate matching module is to find best matching candidates, preferably without human intervention, in response to the user's requirements from a database of candidates, which may be provided separately from the database 14. An ideal candidate is the one who has most related skills and job title relative to the user's required skills and job title.

A challenge here is that the candidates' profiles may not include exactly word-to-word matching skills or job title, which the user 38 has requested. For example, if the user's requirements include Microsoft Word as a required skill, and one candidate has Microsoft Office as one of his skills, this candidate may be a good match to the user's request although it is not a verbatim matching skill that the user has requested.

To resolve this issue, the correlation algorithm described above may be used to give more power to a matching module (or matching engine). The input of the matching module is the user's qualification information for a group and its output is the list of candidates that best match the user's requirements. With each candidate, the matching module may provide a matching percentage for each candidate, which represents the extent to which each candidate matches the user's requirements. An example of a matching percentage for a plurality of candidates is shown in the table below.

| Candidate name | Matching percentage |
|---|---|
| 1- Jane | 100% |
| 2- Mohamed | 90% |
| 3- Huang | 85% |

Next, a start date algorithm is described. An objective of the start date algorithm is to calculate the nearest date possible to start working for the service or the team requested by the user. The algorithm may determine the nearest start date by multilayered calculations using data from the qualification information, the candidates database, and correlation algorithm output.

For each group, there are 5 following main scenarios:

Scenario 1—Identical records are found in the candidate database; Scenario 2—No identical record exists in the candidate database and no weak correlation is identified by the correlation algorithm;

Scenario 3—No identical record exists in the candidate database and only one weak correlation exists;

Scenario 4—No identical record exists in the candidate database and two or more weak correlations exist; and

Scenario 5—No identical record exists in the candidate database and one or more very weak correlations exist.

The following table illustrates exemplary cases for scenario 1, where identical records are found in the candidate database.

| | Case A | Case B | Case C | Case D |
|---|---|---|---|---|
| Group Size | 2 or less | 2 or less | 2 or less | 2 or less |
| # of identical people records: | ≥3 | 3 >> 1 | 1 | 1 >> 0 |
| group size | | | | |
| Nearest Start period of the group | 2 days | 4 days | 5 days | 6 days |

The following table illustrates an exemplary case for scenario 2, where no identical record exists in the candidate database and no weak correlation is identified by the correlation algorithm.

| | Case A |
|---|---|
| Group Size | 2 or less |
| # of identical people records: | 0 |
| group size | |
| Nearest Start period of the group | 7 days |

The following table illustrates an exemplary case for scenario 3, where no identical record exists in the candidate database and only one weak correlation exists.

| | Case A |
|---|---|
| Group Size | 2 or less |
| # of identical people records: | 0 |
| group size | |
| Nearest Start period of the group | 10 days and issues a warning |

The following table illustrates an exemplary case for scenario 4, where no identical record exists in the candidate database and two or more weak correlations exist.

| | Case A |
|---|---|
| Group Size | 2 or less |
| # of identical people records: | 0 |
| group size | |
| Nearest Start period of the group | 14 days and issues a warning |

The following table illustrates an exemplary case for scenario 5, where no identical record exists in the candidate database and one or more very weak correlations exist.

| | Case A |
|---|---|
| Group Size | 2 or less |
| # of identical people records: | 0 |
| group size | |
| Nearest Start period of the group | 18 days and issues a warning |

In accordance with one aspect of the present application, a normalization calculation may be performed to map to each actual group size in case the group size is larger than 2 candidates. The table below illustrates additional days needed for groups larger than 2 candidates.

| | Group Size | | | |
|---|---|---|---|---|
| | 3 or 4 | 6 or 7 | 9 or 10 | 13 till 20 |
| | or 5 | or 8 | or 11 or 12 | (inclusive) |
| All scenarios/Cases | +4 days | +7 days | +10 days | +20 days |

For example, for a group of 8 candidates of the above-described Scenario 1, Case C, the start period will be 12 days (5 days (from the calculations of this case)+7 days (from the table)). The next step is to calculate the start date for the team, which may be obtained by the following factoring formula,

Team Start Date=Current date+A+Σₓ₌₁ⁿ⁻¹0.7F(x) where n|>=2

wherein

n denotes the order of each group;

A denotes the largest start period of all groups; and

F(n) denotes a Group n start period (except the Group of largest period A).

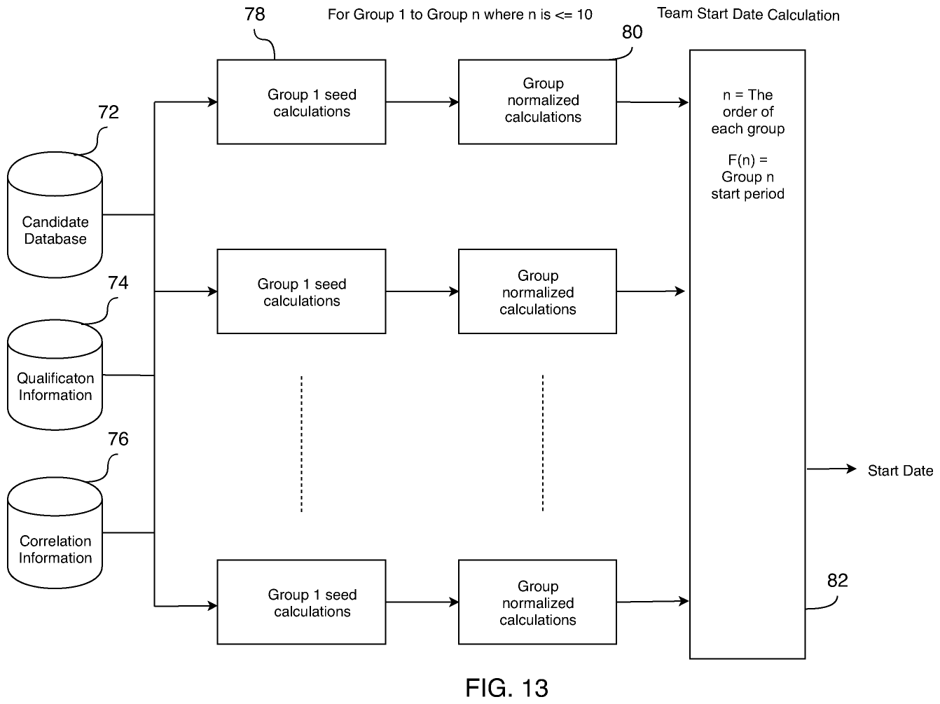

The process of the above-described start date algorithm is schematically illustrated in FIG. 13. According to an exemplary embodiment, the start date algorithm may be based on data in the candidate database 72, qualification information 74, and correlation information 76. Subsequently, the process continues with one or more Group seed calculations 78 and one or more Group normalized calculations 80. Finally, the start date for the team 82 is calculated using the formula above.

As shown in FIG. 13, the system 10, via the application 28, estimates a next available start time for a team or service at least based on the processed qualification information. Preferably, the system 10, via the application 28, estimates a next available start time for a team or service by way of processing data from the candidate database 72, the qualification information 74, and the correlation information 76.

According to one aspect of the present application, the system 10, using an algorithm, generates an estimated start date base on multilayered data analysis that are related to the qualification information, the availability of registered candidates who can qualify for the team or deliver the service, and the analysis of the matching correlation. A correlation algorithm using artificial intelligence techniques may be used to warrant a realistic service or team, a realistic quote (e.g., falling within market price ranges), or a suitable service start date.

Referring to FIG. 2, the output 42 (e.g., a quote) may be displayed to the user 38 via the output interface (or display interface) 36 according to a preferred embodiment. In case the request from the user 38 involves multiple groups (or teams), the display interface 36 may be configured to display results for the multiple groups (or teams).

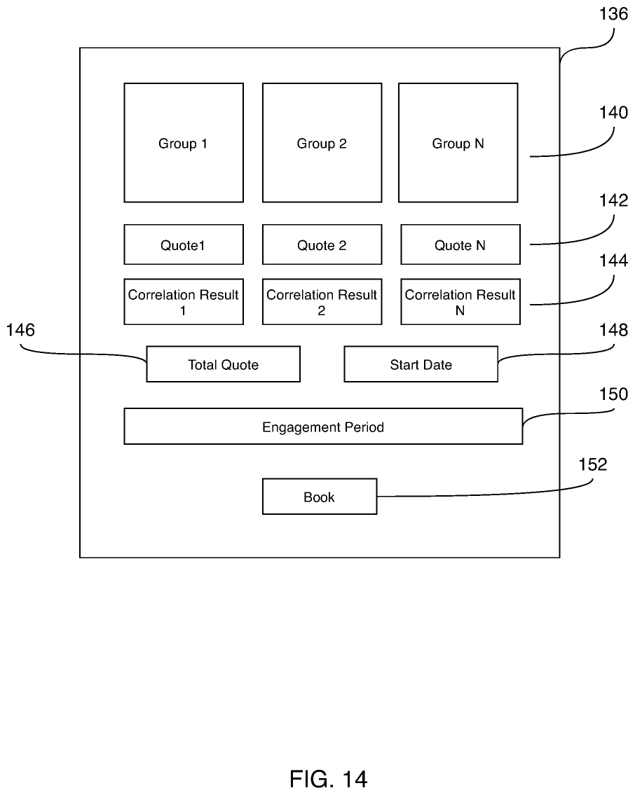

FIG. 14 illustrates a display interface 136 when the user 38 selects multiple groups 140. The display interface 136 may display a quote 142 and correlation result 144 for each group 140. The total quote 146 is a sum of each quote 142. The display interface 136 may display a next available start date 148 for a team or a service. The user 38 may change an engagement period for a team or a service via an engagement period bar 150 such that the engagement period can be conveniently adjusted. In response to changes in the engagement period, the quote 142, the correlation result 144, the total quote 146, and/or the start date 148 may be subject to change. Once the user 38 agrees with the results (e.g., the total quote 146 and the start date 148) displayed in the display interface 136, the user 38 may complete the booking process by way of clicking on a book button 152.

While the above-described display interface 136 is illustrated using multiple groups 140, it is similarly applicable to a situation when the user 38 selects a single service or a single group. Further, the display interface 136 may have a configuration different than what is shown in FIG. 14. For example, the display interface 136 may include multiple windows instead of a single window, or display additional items or buttons (e.g., displaying a discount amount depending on the duration of the engagement period) or omit some items. For another example, the display interface 136 may include a save button such that the user 38 may save what he has selected. Such changes are within the scope of the subject matter presented herein.

In a preferred embodiment, the system 10 employs an input interface 34 that receives users' qualification information, process this information, and generate a quote along with multiple other important outputs that are essential for the users to book a service or team quickly, successfully, and in an efficient way.

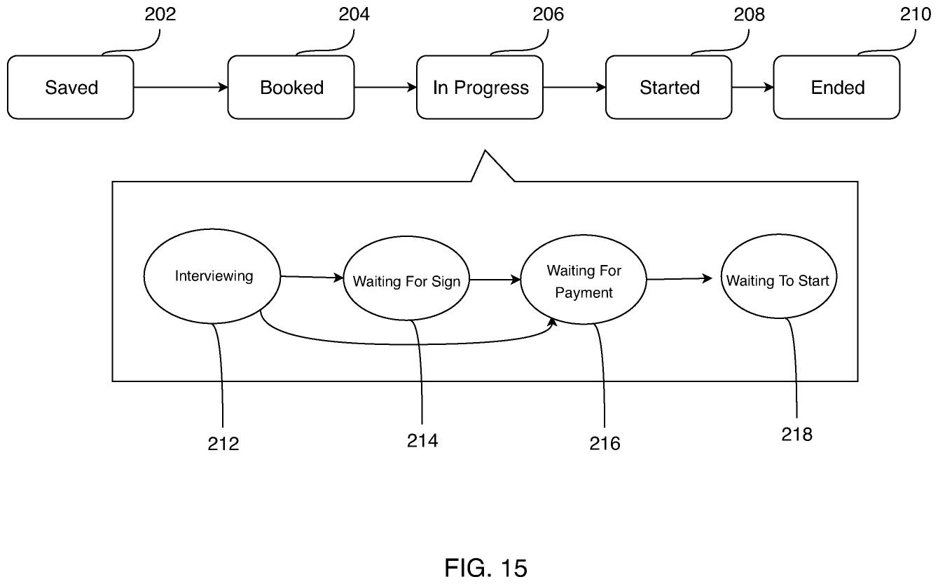

FIG. 15 is a diagram that schematically illustrates a post-booking process once the user 38 completes booking a service or a team via the system 10. Once a quote is generated with an estimated start date, the user 38 can have an option to book the service or the team. The user 38 may save 202 his selections for the service or the team, and complete the booking 204 by way of clicking on the book button 152 (shown in FIG. 14). Upon completion of the booking 204, the process enters a “In Progress” phase 206. During the “In Progress” phase 206, the user 38 may be contacted for an interview 212 (e.g., a telephonic interview) to confirm his intention to employ the service or the team of his selection. Subsequent to waiting for a sign 214 on a contract from the user 38 and payment 216 from the user 38, the status changes to “Waiting To Start” 218. As the service gets started 208, progresses, and ends 210, the status may be updated accordingly.

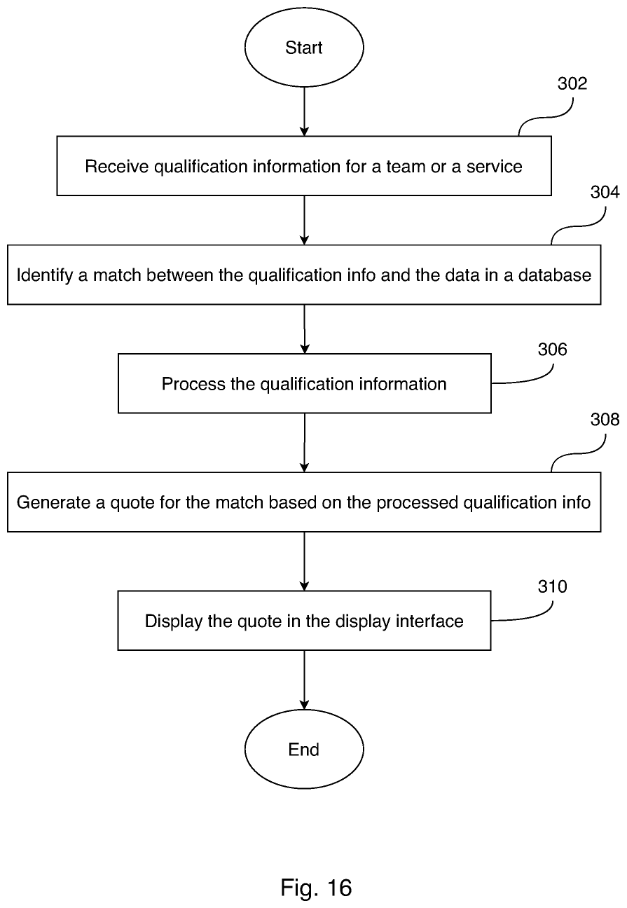

Next, a method for generating a quote for a team or a service is explained in reference to FIG. 16. FIG. 16 is a flow chart that shows a process of generating a quote for a team or service in accordance with an exemplary embodiment of the present application.

The method starts with receiving, via an online interface, qualification information required for either a team or a service in need (step 302). The qualification information may include a job title, a skill, a language, an experience level, and a required number of people.

The next step is to identify at least one match between the qualification information and data in a database including data on jobs and skills (step 304). As described above, fuzzy logic may be used to identify which job title or skill a user wants even when typing of the user fails to exactly what is available in the database.

The next step is to process the qualification information (step 306). As described above referring to FIG. 8, processing of the qualification information is performed. Based on the processed qualification information, a quote for one or more matches for the team or service is generated (step 308).

In a preferred embodiment, the quote is displayed in a display interface (step 310). In some embodiments, other features such as a correlation result and a next available start date may be displayed as well.

It should be noted that the features described above with respect to the system 10 referring to FIGS. 1-15 are likewise applicable to the method for generating a quote for a team or a service in accordance with embodiments of the present application. Hence, detailed discussions of such features are omitted to avoid unnecessary repetition.

According to the system and/or method of the present application, conventional manual, complication, and time-consuming B2B processes are transformed into an automated, easy, and quick processes that users can use on any computing device.

For example, the system and/or method of the present application receives the request from the user (e.g., qualification information), generates a quote immediately on the display interface, and suggests a start date without any human intervention, which saves tremendous amount of money and time, and transforms the hectic experience into another easy and quick experience. This novel system and/or method also extends a new level of trust and clarity between businesses contrary to conventional systems or methods, where price variations in services in technology sectors often lead to overpricing situations. However, by way of the system and/or method of the present application, users can get a clear and precise quote without the need to spend weeks waiting for a manual quote from the service provider.

According to one aspect of the present application, the system and/or method of the present application manages to transform the natural, disconnected and unstructured data into meaningful digital line items of data that can be quantified altogether, and to be used to generate quotes and suggest a start date for users based on the users' selections. One of the key aspects of the system and/or method of the present application is to detect correlations between users' selections and guide the users in case any miscorrelated selections occur, thus making sure that the users can always select a valid service or team.

While particular aspects and embodiments are disclosed herein, other aspects and embodiments will be apparent to those skilled in the art in view of the foregoing teaching. The various aspects and embodiments disclosed herein are for illustration purposes only and are not intended to be limiting, with the true scope and spirit being indicated by the following claims.

What is claimed is:

1. A system comprising:
a database including data on jobs and skills;
a processor; and
an application executed by the processor, the application configured to:
receive, via an online interface, qualification information required for either a team or a service in need;
identify at least one match between the qualification information and the data in the database;
process the qualification information; and
generate a quote for the at least one match for the team or service based on the processed qualification information.

2. The system according to claim 1, wherein the reception of the qualification information, the identification of the at least one match, the processing of the qualification information, and the generation of the quote are conducted without human intervention.

3. The system according to claim 1, wherein the application is further configured to display the quote in a display interface.

4. The system according to claim 1, wherein the application is configured to estimate a next available start time for the team or service at least based on the processed qualification information.

5. The system according to claim 1, wherein the database is a structured database of skills and job titles, which includes descriptive or indicative data to be used for further processing.

6. The system according to claim 1, wherein the application is configured to generate the quote for the at least one match using selected qualification information and corresponding data from the database.

7. The system according to claim 1, wherein
the qualification information of the team includes a job title or a skill, a language, an experience level, a number of candidates, and an engagement period, and
the qualification information of the service includes a job title, a skill, a language, an experience level, or a number of candidates.

8. The system according to claim 1, wherein the application is configured to display a degree of correlation between at least two matches using an algorithm.

9. The system according to claim 8, wherein the application is configured to, by way of the algorithm, suggest other qualification information records that have higher correlation with matched data than the qualification information.

10. The system according to claim 1, wherein
the team includes a plurality of groups, each group having a different set of the qualification information, and
the application is configured to generate a quote for the each group.

11. A method for generating a quote for a team or service, the method comprising:
receiving, via an online interface, qualification information required for either a team or a service in need;
identifying at least one match between the qualification information and data in a database including data on jobs and skills;
processing the qualification information; and
generating a quote for the at least one match for the team or service based on the processed qualification information.

12. The method according to claim 11, wherein the reception of the qualification information, the identification of the at least one match, the processing of the qualification information, and the generation of the quote are conducted without human intervention.

13. The method according to claim 11, the method further comprising:
displaying the quote in a display interface.

14. The method according to claim 11, the method further comprising:
estimating a next available start time for the team or service at least based on the processed qualification information.

15. The method according to claim 11, wherein the database is a structured database of skills and job titles, which includes descriptive or indicative data to be used for further processing.

16. The method according to claim 11, wherein the generation of the quote for the at least one match is conducted using selected qualification information and corresponding data from the database.

17. The method according to claim 11, wherein
the qualification information of the team includes a job title or a skill, a language, an experience level, a number of candidates, and an engagement period, and
the qualification information of the service includes a job title, a skill, a language, an experience level, or a number of candidates.

18. The method according to claim 11, the method further comprising:
displaying a degree of correlation between at least two matches using an algorithm.

19. The method according to claim 18, the method further comprising:
by way of the algorithm, suggesting other qualification information records that have higher correlation with matched data than the qualification information.

20. The method according to claim 11, wherein the team includes a plurality of groups, each group having a different set of the qualification information,
the method further comprising:
generating a quote for the each group.
